(19) United States
(12) Patent Application Publication
(10) Pub. No.: US 2003/0039813 A1
(43) Pub. Date: Feb. 27, 2003

(54) High performance dielectric layer and application to thin film electroluminescent devices

(76) Inventors: Adrian Kitai, Mississauga (CA); Kenneth Cook, Waterloo (CA); Xiaohua Deng, Hamilton (CA); Doris Stevanovic, Dundas (CA)

Correspondence Address: Ralph A. Dowell, Dowell & Dowell, P.C., Suite 309, 1215 Jefferson Davis Hwy., Arlington, VA, 22202, US

(21) Appl. No.: 10/225,467

(22) Filed: Aug. 22, 2002

Related U.S. Application Data
(60) Provisional application No. 60/314,170, filed on Aug. 23, 2001.

(51) Int. Cl. B32B 7/02; H05B 33/12

(52) U.S. Cl. 428/212; 428/332; 428/690; 428/701; 428/702; 313/503; 313/509; 427/419.2

(57) ABSTRACT

The present invention provides thin film dielectrics, and methods of producing them, with high-K performance, and high breakdown field strength and with self-healing breakdown properties. In one aspect there is provided a multilayer dielectric film having an interrupted grain structure, comprising a first sub layer comprising a first dielectric material having a columnar grain structure having a first orientation, a second sub layer comprising a second dielectric material on top of said first layer having an equiaxed grain structure that is different from the first sub layer and a third sub layer comprising third dielectric material on top of said second layer having a microstructure that is different from the second sub layer to provide an interrupted grain structure through said multilayer dielectric film. This multilayer dielectric structure may be used as the dielectric layer in capacitors or electroluminescent laminates when the dielectric constant of the three layers is at least 100 and in a thickness range of 0.5 μm to 10 μm.

### CROSS REFERENCE TO RELATED U.S. PATENT APPLICATION

This patent application relates to U.S. provisional patent application Serial No. 60/314,170 filed on Aug. 23, 2001 entitled HIGH PERFORMANCE DIELECTRIC LAYER AND APPLICATION TO THIN FILM ELECTROLUMINESCENT DEVICES.

### FIELD OF THE INVENTION

The present invention relates to electroluminescent laminates that include a thin film electroluminescent phosphor layer and one or more dielectric layers.

### BACKGROUND OF THE INVENTION

Thin film electroluminescent (TFEL) devices typically include a laminate or laminar stack of thin films deposited on an insulating substrate. The thin films include a transparent electrode layer and a series of layers, typically comprising an EL phosphor material sandwiched between a pair of insulating layers. A second electrode layer completes the laminate structure. In matrixed addressed TFEL displays the front and rear electrodes form orthogonal arrays of rows and columns to which voltages are applied by electronic drivers, and light is emitted by the EL phosphor in the overlap area between the rows and columns when voltage is applied in excess of a voltage threshold.

In designing an EL device, a number of different requirements have to be satisfied by the laminate layers and the interfaces between these layers. To enhance electroluminescent performance, the dielectric constants of the insulator layers should be high. The breakdown field of the insulator layer should also be high. To work reliably however, self-healing of the EL device is desired, in which electric breakdown if it occurs is limited to a small localized area of the EL device i.e. the electrode material covering the dielectric layer decomposes or evaporates at the local area, preventing further breakdown. Only certain dielectric and electrode combinations have this self-healing characteristic. At the interface between the phosphor and insulator layers, compatibility between materials is required to promote charge injection and charge trapping, and to prevent the interdiffusion of undesirable atomic species under the influence of high electric fields during operation, and at the elevated temperatures required during the fabrication process of the EL device.

Typical EL thin film insulators, such as SiO₂, Si₃N₄, Al₂O₃, SiOₓN_{y}, SiAlOₓN_{y} and Ta₂O₅ have relative dielectric constants (K) in the range of 3 to 60 which we shall refer to as low K dielectrics. These dielectrics do not provide optimum EL performance due to their relatively low dielectric constants. A second class of dielectrics, called high K dielectrics, offer higher performance. This class includes materials such as SrTiO₃, BaTiO₃, PbTiO₃ which have relative dielectric constants in the range of 100 to 10,000. These are generally polycrystalline with the perovskite structure. While these high K dielectrics generally exhibit a sufficiently high figure of merit (defined as the product of the breakdown electric field and the relative dielectric constant) not all of these materials offer sufficient chemical stability and compatibility in the presence of high processing temperatures that may be required to fabricate an EL device, and are generally known not to offer the self-healing characteristics essential for reliable EL device operation.

In view of the multiple and often conflicting requirements placed on the insulating layers and their interfaces, multicomponent insulator structures have been proposed. It is known in the art that SrTiO₃, BaTiO₃ can be used in EL devices. For example, U.S. Pat. No. 4,857,802 to Fuyama discusses the use of SrTiO₃ and BaTiO₃ insulating layers. However, this patent teaches how to grow the perovskite structure dielectrics in a [111] crystal orientation to improve breakdown strength. The incorporation of self-healing breakdown functionality is not addressed.

U.S. Pat. No. 4,547,703 to Fujita teaches the use of a multi-layer insulator comprised of non-self healing dielectric layers combined with self healing dielectric layers. In this case, a self-healing, low K dielectric is adjacent to a sulfide phosphor, and the primary rationale for including the non-self-healing dielectric in the EL device is to increase the performance of the insulating layer, thereby increasing the electric field in the phosphor and increasing the charge transfer into the phosphor during emission. In this case, the performance is still limited by a low K dielectric.

U.S. Pat. No. 4,897,319 to Sun teaches the use of a multi-layered insulator in an EL device. However, in Sun's devices, no high K dielectrics are employed, and he teaches that it is essential to have a SiON layer (a low K dielectric) adjacent to a sulfide phosphor.

Kitai et. al. in co-pending U.S. patent application Ser. No. 09/511,729, dated Feb. 23, 2000, teaches a structure where a high K dielectric layer was applied first to a phosphor, to provide a better interface for oxide phosphors, and a low K dielectric is applied to the high K dielectric, with an electrode applied to the low K dielectric to provide self-healing behavior. As in Fujita's case, the low K dielectric limits the performance of the device.

Thus, a variety of two component insulators have been proposed in which a low dielectric constant material maintains the self-healing behavior of the device, and a high dielectric constant material layer increases the electric field in the phosphor. However, in all of these cases, the presence of the low K dielectric material limits the performance of the device. While high K dielectric materials such as SrTiO₃ and BaTiO₃ exhibit desirable interface and charge injection properties with oxide phosphors, they also exhibit a propagating breakdown mode in thin films.

A solution to the problem of propagating breakdown was proposed by Wu (U.S. Pat. Nos. 5,679,472; 5,702,565; 5,756,147 and 5,634,835) in which thick film, high dielectric constant dielectrics in the range of 20 μm thick, are deposited by a combination of screen printing and sol-gel methods, and are generally based on lead-containing materials such as PbTiO₃ and related compounds. Although, due to their thickness, these dielectrics offer self healing breakdown protection, they limit the processing temperature of the phosphors that are deposited on top of the dielectric layer, preventing the use of phosphor materials requiring higher annealing temperatures such as oxide EL phosphors and many sulphide phosphors. Whereas sulphide EL phosphors such as ZnS:Mn may be processed at temperatures below 600° C., oxide EL phosphors and many sulphide phosphors having colour emission such as SrS:Cu,Ag may require processing temperatures of 700° C. or higher. Dielectric formulations containing lead may lead to undesirable migration of lead at these temperatures. Furthermore, the lead containing dielectrics generally cannot be deposited on top of (i.e. after) the phosphor due to lead migration during sintering of the dielectric.

This dielectric structure offers the further disadvantage of having to process materials containing lead, which creates environmental concerns during manufacture and disposal of the device at the end of its life.

Finally, this dielectric material is reflective, which reduces contrast. This creates a problem in that the dielectric cannot be used with known contrast enhancement methods employed in thin film EL devices and creates contrast problems due to ambient light reflecting off of the dielectric.

Therefore, it would be very advantageous to provide thin film high-K dielectric layers with a high breakdown voltage and which provide a self-healing mode of operation which may be used with traditional sulfide EL phosphors and allow the use of other phosphors such as oxides, while also being transparent to facilitate the use of contrast enhancement mechanisms. An electrically robust dielectric layer with a high figure of merit is advantageous to provide proper electron trapping and charge injection in the presence of high electric fields. At the same time, the material must not react with the phosphor during high temperature processes in manufacture, nor allow chemical reaction or inter-diffusion of undesirable chemical species between the phosphor or the adjacent layer in the presence of high electric fields. Such a dielectric layer may also be used in other applications such as capacitor manufacture. In this case, the capacitor structure comprises the dielectric layer sandwiched between a pair of conducting layers. The capacitor thus formed exhibits high breakdown voltage and high capacitance due to the robustness and high K value inherent in the dielectric which is the subject of this invention.

A number of other applications of dielectrics exist in the electronics industry, such as substrates for microwave striplines, substrates to form delay lines and transmission lines and in plasma display devices or liquid crystal display devices or sensor devices. It is the intent of this disclosure to include the use of the dielectric layer in such other applications.

### SUMMARY OF THE INVENTION

It is an object of the present invention to provide thin film dielectrics, and methods of producing them, with high-K performance, and high breakdown field strength.

It is a further object of the present invention to develop EL device structures based on thin film dielectrics with high-K performance, high breakdown field strength and with self-healing breakdown properties.

It is a further object of the present invention to provide thin-film high-K dielectrics that enable high light output performance and self-healing in EL device structures that employ EL phosphors.

It is a further object of the present invention to provide thin-film high-K dielectrics that enable high light output performance and self-healing in EL device structures that employ oxide EL phosphors.

It is a further object of the present invention to provide thin-film high-K dielectrics that enable high light output performance and self-healing in EL device structures that employ sulphide EL phosphors.

The high dielectric constant materials employed provide for a high capacitance layer. When employed in thin film EL devices, this higher capacitance increases the electric field in the phosphor and increases the charge transfer into the phosphor during emission.

A polycrystalline thin film may be characterized by its microstructure. Microstructure describes the size, shape and orientation of the crystalline grains in the thin film. The multilayer thin film described herin is characterized by two or more layers, each layer being a polycrystalline thin film, such that its microstructure is distinct from the adjacent layer or layers. Therefore the grains differ from one layer to the next in one or more aspects of their size, shape and/or orientation.

In one aspect of this invention there is provided a multilayer dielectric film with an interrupted grain structure, comprising:

a first layer comprising a first dielectric material having a columnar grain structure, and at least a second layer comprising a second dielectric material on top of said first layer having an equiaxed grain structure that is different from the first layer grain structure to give an interrupted grain structure through said multilayer dielectric film.

In this aspect of the invention the multilayer dielectric film may include a third layer comprising a dielectric material on top of said second layer having a columnar grain structure that has a third orientation that is different from said second layer grain structure.

In another aspect of the invention there is provided a capacitor comprising:

an electrically insulating substrate;

a conducting layer on a surface of the substrate;

a dielectric layer on the conducting layer having a dielectric constant of at least 100, said dielectric layer being in the range of 0.5 μm to 10 μm in thickness;

a second conducting layer on the dielectric layer.

In another aspect of the invention there is provided an electroluminescent laminate, comprising:

an electrically insulating transparent substrate;

a conducting transparent metal oxide layer on a surface of the substrate;

a first dielectric layer on the conducting layer with a dielectric constant in the range 100 to 10,000 and a thickness 0.01 μm to 0.5 μm;

an electroluminescent phosphor layer on the first dielectric layer;

a second dielectric layer having a dielectric constant of at least 100, said dielectric layer being in the range of 0.5 to 10 μm in thickness. a second conducting layer on the second dielectric layer, wherein the EL laminate device thus constructed is characterized by self-healing breakdown properties.

In another aspect of the invention there is provided an electroluminescent laminate, comprising;

an electrically insulating transparent substrate;

a conducting transparent metal oxide layer on a surface of the substrate;

an electroluminescent phosphor layer on the conducting layer;

a dielectric layer having a dielectric constant in the range of at least 100, said dielectric layer being in the range of 0.5 μm to 10 μm in thickness.

a second conducting layer on the dielectric layer, wherein the EL laminate device thus constructed is characterized by self-healing breakdown properties.

In another aspect of the invention there is provided an electroluminescent laminate, comprising an electrically insulating substrate;

a conducting layer on a surface of the substrate;

a first dielectric layer on the conducting layer with a relative dielectric constant in the range 100 to 10,000 and thickness in the range 0.01 μm to 0.5 μm;

an electroluminescent phosphor layer on the interface layer;

a second dielectric layer on the phosphor layer having a dielectric constant of at least 100, said dielectric layer being in the range of 0.5 μm to 10 μm in thickness.

a second transparent conducting layer on the second dielectric layer, wherein the EL laminate device thus constructed is characterized by self-healing breakdown properties.

In another aspect of the invention there is provided an electroluminescent laminate, comprising an electrically insulating substrate;

a conducting layer on a surface of the substrate;

an electroluminescent phosphor layer on the conducting layer;

a dielectric layer on the phosphor layer having a relative dielectric constant of at least 100, said dielectric layer being in the range of 0.5 to 10 μm in thickness.

a second conducting layer that is transparent on the dielectric layer, wherein the EL laminate device thus constructed is characterized by self-healing breakdown properties.

In another aspect of the invention there is provided an electroluminescent laminate, comprising:

an electrically conductive substrate;

a first dielectric layer on the conducting substrate with a relative dielectric constant in the range 100 to 10,000 and a thickness in the range 0.01 μm to 0.5 μm;

an electroluminescent phosphor layer on the interface layer;

a second dielectric layer on the phosphor layer having a dielectric constant of at least 100, said dielectric layer being in the range of 0.5 μm to 10 μm in thickness;

a second conducting layer that is transparent on the second dielectric layer, wherein the EL laminate device thus constructed is characterized by self-healing breakdown properties.

In another aspect of the invention there is provided an electroluminescent laminate, comprising; an electrically conductive substrate;

an electroluminescent phosphor layer on the conducting substrate;

a dielectric layer having a dielectric constant of at least 100 and having a perovskite structure, said dielectric layer being in the range of 0.5 to 10 μm in thickness.

a transparent conducting layer on the dielectric layer, wherein the EL laminate device thus constructed is characterized by self-healing breakdown properties.

### BRIEF DESCRIPTION OF THE DRAWINGS

The invention will now be described, by way of example only, reference being had to the accompanying drawings, in which:

FIG. 1 is a cross sectional view of the structure of a capacitor device constructed in accordance with the present invention;

FIG. 2 is a cross sectional view of a structure of a thin film electroluminescent (TFEL) device constructed in accordance with the present invention;

FIG. 3 is a graph showing both brightness and efficiency versus voltage of electroluminescence obtained from the device of FIG. 2;

FIG. 4 is a plan view scanning electron micrograph (SEM) of the sputtered SrTiO₃ layer corresponding to sub layer 1;

FIG. 5 is an atomic force micrograph (AFM) of the sol-gel deposited SrTiO₃ layer corresponding to sub layer 2; and

FIG. 6 shows a cross-sectional view of a completed capacitor.

### DETAILED DESCRIPTION OF THE INVENTION

The present invention demonstrates that for the first time thin film dielectrics with a relative dielectric constant of K>100 may be used to form high light-output EL laminate devices without employing low K dielectrics to achieve self-healing properties. This is achieved by producing multilayer dielectric films with an interrupted grain structure through the thickness of the dielectric layer. As used herein the term multilayer refers to a layered structure with at least two different layers one on top of the other each having a different microstructure to give an interrupted grain structure through the thickness of the multilayer structure. The microstructure is defined by grain size, grain orientation and grain shape and as long as at least one of them is different between adjacent sub layers of the multilayer film, an interrupted grain structure will be obtained. As will be discussed, this can be achieved using the same dielectric material grown under different conditions for each sub layer making up the multilayer laminate or it can be different dielectric materials in each sub layer with a different microstructure. The electroluminescent (EL) devices produced according to the present invention demonstrate steep brightness-voltage behavior. A variety of common substrates can be used including glass, fused silica, ceramic glass and glazed or polished ceramic, and suitable metals.

FIG. 1 shows a capacitor 10 comprising a Corning 1737 glass substrate 12 with a conducting transparent indium tin oxide (ITO) electrode 14 of a thickness of ˜150 nm grown by commercial supplier Applied Films Inc.

The dielectric layer 16 was deposited in three sub-layers. First, for sub layer 1, an RF sputter deposition system with a 6.5-inch diameter SrTiO₃ (99.9%) target was used to grow a SrTiO₃ thin film with a thickness of approximately 900 nm.

During deposition, the substrates were heated up to 600° C. The sputtering gas was a mixture of argon (99.999% purity) and oxygen (99.98% purity) with an O₂/(Ar+O₂) ratio of 40%, and the sputtering pressure was controlled at 10 mTorr. The layer of SrTiO₃ was grown in 60 minutes.

Next, after removal from the sputtering chamber, deposition of sub layer 2 was performed by a sol-gel technique. From starting materials H₂O (HPLC Grade), HNO₃ (99.99%), Ethylene Glycol (99%), L-tartaric acid, Sr(NO₃)₂ (99.9965%), titanium isopropoxide Ti(OC₃H₇)₄ (99.999%) the following procedure was performed:

10 grams of HNO₃ was diluted with 50 grams of H₂O in a beaker. Ti(OC₃H₇)₄ was transferred to the HNO₃ solution with a pipette while stirring the mixture until 5.80 grams of Ti(OC₃H₇)₄ was added. The solution was stirred continuously until it became clear.

Next. 20 grams of ethylene glycol and 0.5 grams of L-tartaric acid was added to the above solution and stirred until the solution again became clear. The solution was heated to 60-70° C. until the solution volume was reduced to 60-70% of the original volume. This forms solution 1.

Next 4.29 grams of Sr(NO₃)₂ was dissolved in 10 grams of H₂O in a beaker while stirring until the solution became clear. Then 10 grams of ethylene glycol and 0.5 grams of L-tartaric acid were added and stirred until the solution became clear. The solution was then heated to 60-70° C. until the solution volume was reduced to 60-70% of the original volume. This forms solution 2.

Next, solutions 1 and 2 were mixed thoroughly, and heated to 60-70° C. The final solution was used to deposit a thin film by spin coating as follows:

The solution was then applied to the surface of the sputtered SrTiO₃ sub layer 1 and then the substrate was spun at 3000 rpm for 20 seconds, followed by drying in air at 60° C. for 5-10 minutes and then at 250° C. in air for 10-20 min. The film, when sintered at 600° C. for 10 minutes in air yielded a SrTiO₃ film thickness of approximately 0.2 μm, with a grain size of approximately 50 nm covering the sputtered SrTiO₃ sub layer 1, and constituting sub layer 2.

The third stage of deposition was now performed in a manner identical to the first sub layer 1 by RF sputtering to a thickness of approximately 900 nm to form sub layer 3.

The final thickness of the completed dielectric is now approximately 2 μm, comprising a 900 nm layer of sputtered SrTiO₃ (sub layer 1), a 200 nm layer of sol-gel SrTiO₃ (sub layer 2), and a further 900 nm layer of sputtered SrTiO₃ (sub layer 3). Whereas the sol-gel SrTiO₃ is characterized by small equiaxed grains of approximately 50 nm in diameter, the sputtered SrTiO₃ layers are characterized by columnar grains oriented vertically, and are up to approximately 200 nm in diameter.

Finally an aluminum electrode 18 of thickness 100 nm was deposited by thermal evaporation.

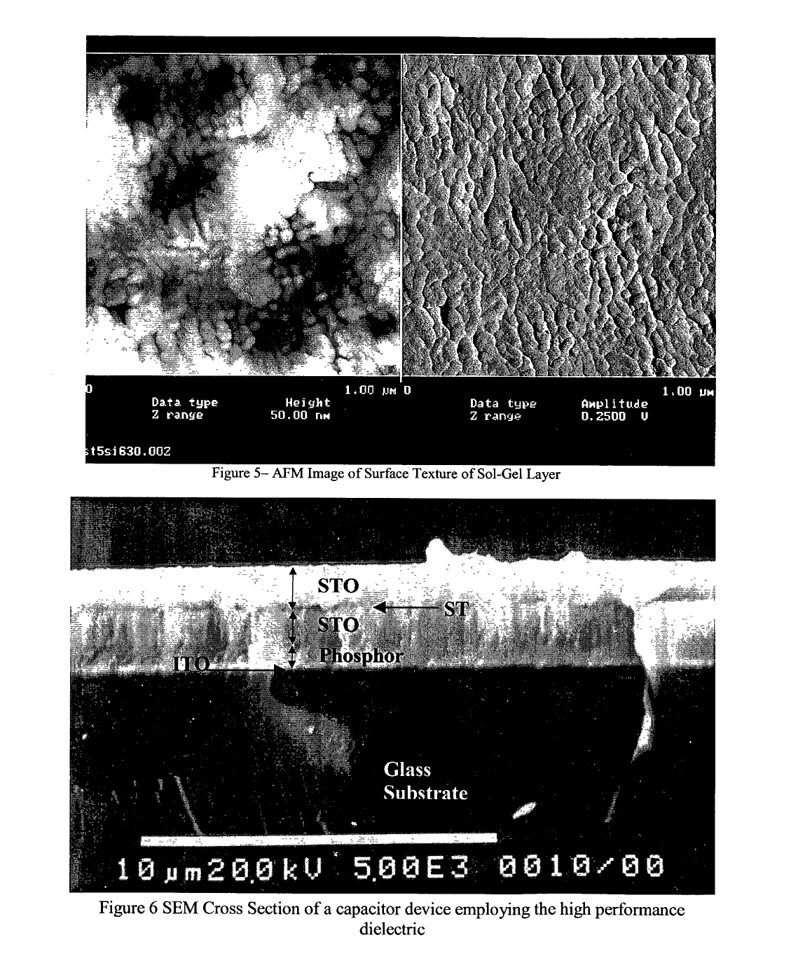

FIGS. 4 and 5 show microstructures of the sub layers. FIG. 4 is a SEM of sub layer 1 in plan view. FIG. 5 is an AFM of sub layer 2. FIG. 6 shows a cross-section view the completed capacitor, wherein sub layers 1 and 3 are labeled STO and sub layer 2 is labeled ST. The aluminum electrodes 18 were patterned in the form of circles of diameter 1 mm by using a stainless steel mask during thermal evaporation.

In the example presented herein, dielectric layer 10 shown in FIG. 6 comprises sub layer 1, sub layer 2 and sub layer 3. Sub layers 1 and 3 are comprised of substantially columnar grains of about 200 nm in diameters and length equal to the film thickness of 900 nm. The long grain axis is therefore normal to the plane of the layer, and grows in length as the growth of the layer proceeds. Sub layer 2 comprises a very fine-grained equiaxed morphology in which there is no significant texture or directionality of the grains. The grains are about 500 Å in diameter, which is much smaller than the grains of sub layers 1 and 3. The grains in sub layer 2 grow due to the nucleation of the sol-gel deposited material during the sintering step. Those grains therefore nucleate independently from the grains in sub layer 1.

The completed capacitors were then tested using AC voltages consisting of 200 μs pulses of alternating polarity at a frequency of 60 Hz. The relative dielectric constant was determined to be 220, and the breakdown voltage for typical samples exceeded ±250 volts (peak). A sample of over 100 devices tested yielded over 75% exceeding±300 volts (peak) in breakdown tests, and only 4% failed to reach ±200 volts (peak) before breakdown.

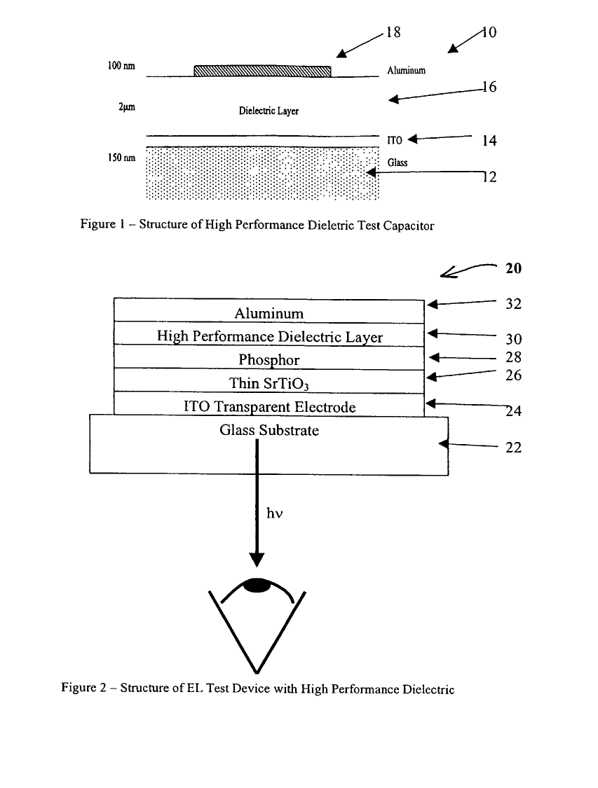

FIG. 2 shows an EL device 20 that was fabricated using the multilayer dielectric film grown as disclosed herein. Corning 1737 substrates 22, coated by a commercial supplier Applied Films Inc. with a conducting bottom electrode layer 24 comprising indium tin oxide (ITO) to a thickness of ˜1500 Å, were coated with a thin 50 nm film 26 of SrTiO₃ by sputter deposition from an SrTiO₃ target using conditions similar to those employed in sub layers 1 and 3 of the dielectric layer described earlier.

Then an electroluminescent phosphor layer 28 was deposited by RF magnetron sputtering from an oxide target to form a thin film of Zn₂Si_{0.5}Ge_{0.5}O₄:Mn of thickness 700 nm. The sample was then annealed in a vacuum to crystallize the phosphor layer 28.

Next, a multilayer dielectric film 30 was deposited using the same method as described with reference to the dielectric layer 16 of the capacitor 10 of FIG. 1. Finally aluminum electrodes 32 of thickness 100 nm in the form of 1 mm diameter circles were deposited by vacuum evaporation.

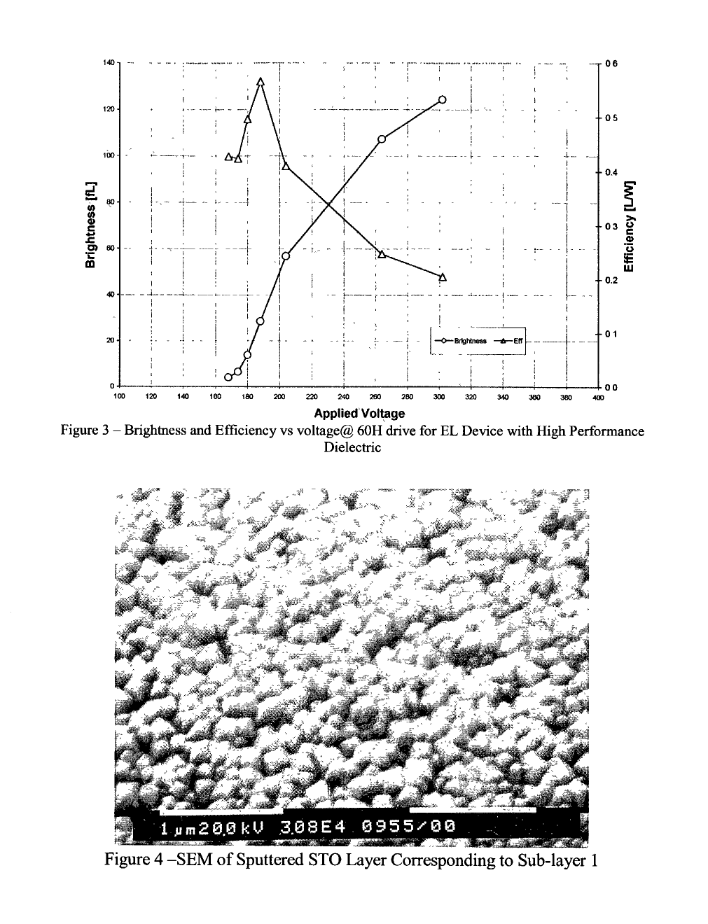

The resulting EL devices 20 were then tested by applying an AC voltage across the ITO and aluminum electrodes. Bright green electroluminescence was visible through the transparent substrate. The brightness and efficiency vs voltage curves are shown in FIG. 3, and the slope of the brightness voltage curve is measured to be greater than that obtained with a similar device using lower K dielectrics. The threshold voltage was also noted to be lower.

The EL device 20 demonstrated self-healing behaviour, in that if an electrically short-circuited or leaky device was tested, the voltage and current could be raised until self-healing took place upon which the EL device no longer exhibited leaky or short-circuited behaviour, but rather behaved as a normal EL device with bright green electroluminescence.

Preferred high K dielectric materials for use in the present invention include thin film dielectrics, such as SrTiO₃ and BaTiO₃ which have relative dielectric constants in the range of 100 to 5,000, and are crystalline with the perovskite structure.

It is likely that the self-healing feature of these devices is due to the multilayered dielectric layer that prevents grains in any layer from extending through the entire dielectric stack. This limits a fault associated with a grain boundary from being present in a continuous path to not more than a single sub-layer.

The multilayered dielectric stack disclosed herein also controls mechanical stress that builds up as the dielectric gets thicker. This stress may be released due to interfaces between sub layers at which the grain structure is interrupted. Excessive stress can cause cracking or delamination leading to electrical and mechanical failure.

In addition, the thickness of the dielectric layer 28 is also believed to be significant. Whereas most thin film dielectrics are in the range of 0.1 to 0.5 μm, the increased thickness of the dielectric layer described in this invention will reduce thermal damage due to electrical breakdown and allow self-healing to occur. This occurs since the heat from a breakdown must allow the electrode to open before it has a chance to damage the dielectric layer. A larger volume of material in the dielectric layer due to increased dielectric layer thickness requires a larger amount of energy and hence time required for thermal damage to occur.

One skilled in the art will recognize that many other high K dielectrics may be employed in this high performance dielectric stack. One would further recognize that this high performance dielectric layer could be inserted in many different configurations in the thin film EL laminate structure. Finally, it is possible to combine the dielectric layers in more than three layers to achieve the desired self-healing behavior.

The various sub layers of the dielectric can be the same material as in the examples presented, or they may be different materials. For example, dielectrics that comprise a three-layer structure wherein sub layer 1 is SrTiO₃, sub layer 2 is PbZr_{1-X}TiₓO₃ and sub layer 3 is SrTiO₃ were also prepared and good dielectric properties were observed. In this structure, sub layers 1 and 3 were sputtered and sub layer 2 was deposited by sol-gel methods.

Various deposition methods may be suitable for the various sub layers. Common thin film deposition methods include sputtering, sol-gel, thermal or electron-beam evaporation, plasma-assisted evaporation, chemical vapor deposition, plasma-assisted chemical vapor deposition, laser ablation and atomic layer deposition. Other deposition methods may include screen printing, electrophoretic deposition or spray pyrolysis. In some cases, changing the deposition method for the sub layers may be necessary, as in the examples presented, however in some cases, the same deposition method might be useable, provided that growth conditions are modified to result in an interrupted grain structure.

It is noted that while typically insulating transparent substrates are used, the base substrate may also be electrically conducting and so the ITO or conducting electrode layer on the substrate may be dispensed with. When the substrate is not transparent the top electrode must be transparent.

The non-limiting exemplary results shown in FIGS. 2 to 4 were obtained using the electroluminescent green phosphor Zn_{2-X}Mn_{X}Si_{Y}Ge_{1-Y}O₄, with a preferred value of X being about 0.04 and a preferred value of Y being about 0.5. The presence of germanium in the zinc silicates produces an efficient green electroluminescent phosphor and has the effect of lowering the processing temperatures to well below a thousand degrees as disclosed in U.S. Pat. Nos. 5,725,801, 5,788,882 and 5,897,812 which are each incorporated herein by reference in their entirety. These patents also disclose highly efficient oxide-based red emitting phosphors, discussed hereinafter, which may also be incorporated into the TFEL devices disclosed herein (data not shown). The red phosphors that may be used in the present TFEL laminates may include Ga₂₋ₓEuₓO₃ with Eu spanning the range of 0.10<x<0.30 and a typical value of x is about 0.17. The range of Eu concentration has been extended from what was claimed in U.S. Pat. No. 5,879,812. In this range (0.10<x<0.30), there is evidence that the Eu need not be fully soluble in Ga₂O₃ and nanocrystalline phases may form. Another EL oxide that may be used is Ca₁₋ₓEuₓGa_{y}O_{z}, wherein x spans the range in which Eu is soluble in Ca₁₋ₓEuₓGa_{y}O_{z}, y is in a range from about 0.5 to about 4, and z is approximately equal to 1+(3/2)y.

Another electroluminescent red emitting phosphor that may be used has a formulation given by Sr₁₋ₓEuₓGa_{y}O_{z}, wherein x spans the range in which Eu is soluble in Sr₁₋ₓEuₓGa_{y}O_{z}, y is from about 0.5 to about 12, and z is approximately 1+(3/2)y.

Another electroluminescent red emitting phosphor film that may be used has a formulation given by Ba₁₋ₓEuₓGa_{y}O_{z}, wherin x spans the range in which Eu is soluble in Ba₁₋ₓEuₓGa_{y}O_{z}, y is from about 0.5 to about 4, and z is approximately 1+(3/2)y.

Another red emitting EL phosphor oxide compound that may be used has a formula Sr₃₋ₓEuₓGa₂O_{z}, wherein x spans the range in which Eu is soluble in Sr₃Ga₂O₆ and z is approximately 6. Another red emitting phosphor that may be used includes the compound having a formula Sr₄₋ₓEuₓGa₂O_{z}, wherein x spans the range in which Eu is soluble in Sr₄Ga₂O₇ and z is approximately 7. Another red emitting phosphor compound that may be used has a formula Sr₇₋ₓEuₓGa₄O_{z}, wherein x spans the range in which Eu is soluble in Sr₇Ga₄O₁₃ and z is approximately 13.

Another electroluminescent red phosphor that may be used is Sr₁₋ₓREₓGa₂O_{z} wherein RE is a rare earth dopant selected from the group consisting of Eu, Tb and combinations thereof, x spans the range in which the rare earths are soluble in SrGa₂O₄ and z is approximately 4.

Other red emitting compounds that may be used include a compound having a formula Sr₁₋ₓEuₓGa₄O_{z} wherein x spans the range in which EU is soluble in SrGa₄O₇ and z is approximately 7. A compound having a formula Sr₁₋ₓEuₓGa₁₂O_{z}, wherein x spans the range in which Eu is soluble in SrGa₁₂O₁₉ and z is approximately 19 may also be used. A compound having a formula Sr₃₋ₓEuₓGa₄O_{z}, wherein x spans the range in which Eu is soluble in Sr₃Ga₄O₉ and z is approximately 9 can be used; as may a compound having a formula Ba₃₋ₓEuₓGa₂O_{z}, wherein x spans the range in which Eu is soluble in Ba₃Ga₂O₆ and z is approximately 6. Another EL compound which can be used has a formula Ba₄ EuₓGa₂O_{z}, wherein x spans the range in which Eu is soluble in Ba₄Ga₂O₇ and z is approximately 7.

Another red emitting electroluminescent oxide phosphor that may be used in the present laminate includes the electroluminescent phosphor having a formula Ba₁₋ₓEuₓGa₂O_{z}, wherein x spans the range in which Eu is soluble in BaGa₂O₄ and z is approximately 4.

These oxide phosphors are highly advantageous because, as disclosed in these patents, they have demonstrated high luminance output and extended life. Further, being oxides, they do not react with atmospheric water vapor and oxygen and so minimal sealing is required in manufacturing the display.

Other oxide phosphors may also be employed, such as those containing other rare earth dopants which emit light of other colours such as Tb, Dy, Tm or transition metal dopants such as Ti and Cr. Since the achievement of a full range of colours is important for EL devices, the range of EL oxide phosphors that may be employed in the current laminate is not to be restricted.

In addition to oxide phosphors, other thin film EL phosphors may be employed. Non-limiting examples of thin film EL phosphors are ZnS:Mn, SrS:Ce, SrS:Cu,Ag, BaAl₂S₄:Eu and CaS:Pb.

This invention demonstrates for the first time that thin film high K dielectrics may be incorporated in TFEL device structures using dielectric layers in the thickness range from submicrons to several microns such that the TFEL device exhibits self-healing breakdown behavior. Those skilled in the art will appreciate that the TFEL structures comprising the conducting electrode layers, phosphors and dielectrics may be deposited in a variety of methods that are well known in the TFEL literature as applied to sulfide phosphors and dielectric materials, see for example Y. Ono, “Electroluminescent Displays”, World Scientific, 1995, Singapore. A range of substrates may also be used including glass, fused silica, ceramic glass, glazed or polished ceramic and a variety of suitable metal substrates. In addition, those skilled in the art will understand that there are many alternative high K dielectric materials that may be used in this structure. Non-limiting examples of appropriate dielectrics include BaTiO₃, (Sr,Ba)TiO₃, SrTiO₃, PbTiO₃, Pb(Ti,Zr)TiO₃, Sr(Zr,Ti)O₃, (Pb,La)(Zr,Ti)O₃, Pb(Mg,Nb)O₃.

Many variations of TFEL devices may be considered that utilize the multilayered dielectric stack disclosed herin. The multilayered dielectric stack may be inserted on any one side of the phosphor layer, or on both sides of the phosphor layer. In the case that the multilayered dielectric stack is inserted on only one side of the phosphor layer, a second dielectric layer may be inserted on the other side of the phosphor layer, or the second layer could be omitted.

Although the dielectric layers discussed herin have dielectric constants of at least 100, it may be advantageous to provide a thin interface layer with a dielectric constant below 100 on one side or both sides of the phosphor layer. Thin interface layers may provide suitable chemical compatibility with the phosphor layer, and may provide charge trapping characteristics to optimize the behavior of the TFEL device. Inasmuch as the thin interface layer is primarily intended for these specific purposes, rather than to provide self-healing dielectric performance of the TFEL device, it is to be considered to fall within the scope of the current invention.

As used herein, the terms “comprises”, “comprising”, “including” and “includes” are to be construed as being inclusive and open ended, and not exclusive. Specifically, when used in this specification including claims, the terms “comprises”, “comprising”, “including” and “includes” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

Therefore what is claimed is:

1. A multilayer dielectric film with an interrupted grain structure, comprising:
a first layer comprising a first dielectric material having a first microstructure, and at least a second layer comprising a second dielectric material on top of said first layer having a second microstructure that is different from the first microstructure to give an interrupted grain structure through said multilayer dielectric film.

2. The multilayer dielectric film according to claim 1 including a third layer comprising a dielectric material on top of said second layer having a third microstructure that is different from said second microstructure.

3. The multilayer dielectric film according to claim 1 wherein said first, second and third dielectric materials each have a relative dielectric constant of at least 100.

4. The multilayer dielectric film according to claim 1 wherein said first, second and third dielectric layers are made of the same dielectric material.

5. The multilayer dielectric film according to claim 1 wherein said first, second and third dielectric materials are different dielectric materials.

6. The multilayer dielectric film according to claim 1 wherein any two of said first, second and third dielectric materials are made of the same dielectric material, and the remaining dielectric layer is a different dielectric material.

7. The multilayer dielectric film according to claim 1 wherein said dielectric material is selected from the group consisting of BaTiO₃, (Sr,Ba)TiO₃, SrTiO₃, PbTiO₃, Pb(Ti,Zr)Ti O₃, Sr(Zr,Ti)O₃, (Pb,La)(Zr,Ti)O₃, Pb(Mg,Nb)O₃.

8. A multilayer dielectric film having an interrupted grain structure, comprising:
a first layer comprising a first dielectric material having a first microstructure;
a second layer comprising a second dielectric material on top of said first layer having a second microstructure that is different from the first microstructure; and
a third layer comprising a third dielectric material on top of said second layer having a third microstructure that is different from the second microstructure to provide an interrupted grain structure through said multilayer dielectric film.

9. The multilayer dielectric film according to claim 8 wherein said first, second and third dielectric materials each have a relative dielectric constant of at least 100.

10. The multilayer dielectric film according to claim 8 wherein said first, second and third dielectric materials are made of the same dielectric material.

11. The multilayer dielectric film according to claim 8 wherein said first, second and third dielectric materials are different dielectric materials.

12. The multilayer dielectric film according to claim 8 wherein any two of said first, second and third dielectric materials are made of the same dielectric material, and the remaining dielectric layer is a different dielectric material.

13. The multilayer dielectric film according to claim 8 wherein said first, second and third dielectric materials are selected from the group consisting of BaTiO₃, (Sr,Ba)TiO₃, SrTiO₃, PbTiO₃, Pb(Ti,Zr)Ti O₃, Sr(Zr,Ti)O₃, (Pb,La)(Zr,Ti)O₃, Pb(Mg,Nb)O₃.

14. The multilayer dielectric film according to claim 8 wherein said multilayer dielectric film has a thickness in a range from about 0.5 μm to about 10 μm.

15. The multilayer dielectric film according to claim 10 wherein said dielectric material has a perovskite crystal structure.

16. The multilayer dielectric film according to claim 8 wherein said dielectric material is selected from the group consisting of BaTiO₃, (Sr,Ba)TiO₃, SrTiO₃ PbTiO₃, Pb(Ti,Zr)Ti O₃, Sr(Zr,Ti)O₃, (Pb,La)(Zr,Ti)O₃, Pb(Mg,Nb)O₃.

17. A method of producing a multilayer dielectric film with an interrupted grain structure, comprising:
a) depositing onto a substrate a first layer of a first dielectric material using a first growth process which results in a first microstructure;
b) depositing onto said first layer a second layer of a second dielectric material using a second growth process which results in a second microstructure which is different from the first microstructure; and
b) depositing onto said second layer a third layer of a third dielectric material using a third growth process which results in a third microstructure that is different from the second microstructure to give a multilayer dielectric film with an interrupted grain structure.

18. The method according to claim 17 wherein said first, second and third dielectric materials are made of the same dielectric material.

19. The method according to claim 17 wherein said first, second and third dielectric materials are different dielectric materials.

20. The method according to claim 17 wherein any two of said first, second and third dielectric materials are made of the same dielectric material, and the remaining dielectric layer is a different dielectric material.

21. The method according to claim 17 wherein said first and third growth processes are the same.

22. The method according to claim 21 wherein said first and third growth processes are radio frequency atomic sputtering of said dielectric material from a target comprising said dielectric material.

23. The method according to claim 22 wherein said second growth process is sol gel synthesis.

24. The method according to claim 17 wherein said first, second and third dielectric materials have a relative dielectric constant of at least 100.

25. The multilayer dielectric film according to claim 17 wherein said dielectric material is selected from the group consisting of BaTiO₃, (Sr,Ba)TiO₃, SrTiO₃, PbTiO₃, Pb(Ti,Zr)Ti O₃, Sr(Zr,Ti)O₃, (Pb,La)(Zr,Ti)O₃, Pb(Mg,Nb)O₃.

26. An electroluminescent laminate, comprising;
an electrically insulating substrate;
a conducting metal oxide layer on a surface of the substrate;
an electroluminescent phosphor layer on the conducting metal oxide layer;
a multilayer dielectric film with an interrupted grain structure on the electroluminescent phosphor layer, said multilayer dielectric film comprising:
a first layer comprising a first dielectric material having a first microstructure, and at least a second layer comprising a second dielectric material on top of said first layer having a second microstructure that is different from the first microstructure to give an interrupted grain structure through said multilayer dielectric film, wherein said first and second dielectric materials each have a relative dielectric constant of at least 100; and
a second conducting layer on a top surface of said multilayer dielectric film, and wherein at least one of the second conducting layer and the conducting metal oxide layer is substantially transparent, and wherein when only said conducting metal oxide layer is substantially transparent, then said substrate is also transparent.

27. The electroluminescent laminate according to claim 26 wherein said multilayer dielectric layer includes a third layer comprising a third dielectric material on top of said second layer having third microstructure that is different from said second microstructure.

28. An electroluminescent laminate, comprising;
an electrically insulated substrate;
a conducting metal oxide layer on the electrically insulated substrate;
an electroluminescent phosphor layer on the metal oxide;
a multilayer dielectric film with an interrupted grain structure on the electroluminescent phosphor layer, said multilayer dielectric film comprising
a first layer comprising a first dielectric material having first microstructure;
a second layer comprising a second dielectric material on top of said first layer having a second microstructure that is different from the first microstructure; and
a third layer comprising third dielectric material on top of said second layer having a third microstructure that is different from the second microstructure to provide an interrupted grain structure through said multilayer dielectric film, said first, second and third dielectric materials each having a relative dielectric constant of at least 100; and
a second conducting layer on a top surface of said multilayer dielectric film, and wherein at least one of the second conducting layer and the conducting metal oxide layer is substantially transparent, and wherein when only said conducting metal oxide layer is substantially transparent, then said substrate is also transparent.

29. The electroluminescent laminate according to claim 28 wherein said dielectric material has a perovskite crystal structure.

30. The electroluminescent laminate according to claim 28 wherein said dielectric material is selected from the group consisting of BaTiO₃, (Sr,Ba)TiO₃, SrTiO₃, PbTiO₃, Pb(Ti,Zr)Ti O₃, Sr(Zr,Ti)O₃, (Pb,La)(Zr,Ti)O₃ and Pb(Mg,Nb)O₃.

31. The electroluminescent laminate according to claim 28 including a dielectric layer sandwiched between said conducting metal oxide layer and said electroluminescent phosphor layer.

32. The electroluminescent laminate according to claim 31 wherein said dielectric layer sandwiched between said conducting metal oxide layer and said electroluminescent phosphor layer has a relative dielectric constant of at least 100 and has a perovskite crystal structure.

33. The electroluminescent laminate according to claim 28 wherein said electroluminescent phosphor layer is an electroluminescent oxide layer.

34. The electroluminescent laminate according to claim 28 wherein said electroluminescent phosphor layer is an electroluminescent sulphide layer.

35. The electroluminescent laminate according to claim 34 wherein said electroluminescent sulphide is selected from the group consisting of ZnS:Mn, SrS:Ce, SrS:Cu,Ag, BaAl₂S₄:Eu and CaS:Pb.

36. The electroluminescent laminate according to claim 28 wherein said multilayer dielectric film has a thickness in a range from about 0.5 μm to about 10 μm.

37. The electroluminescent laminate according to claim 31 wherein said dielectric film has a thickness in a range from about 0.01 μm to about 0.5 μm.

38. The electroluminescent laminate according to claim 28 wherein said first, second and third dielectric materials are made of the same dielectric material.

39. The electroluminescent laminate according to claim 28 wherein said first, second and third dielectric materials are different dielectric materials.

40. The electroluminescent laminate according to claim 28 wherein any two of said first, second and third dielectric materials are made of the same dielectric material, and the remaining dielectric layer is a different dielectric material.

41. The electroluminescent laminate according to claim 1 wherein said first and second layers are crystalline.

42. The electroluminescent laminate according to claim 8 wherein said first, second and third dielectric layers are crystalline.

43. The electroluminescent laminate according to claim 28 wherein said first, second and third layers are crystalline.

44. A capacitor, comprising:
an electrically insulating substrate;
a conducting layer on the substrate;
a multilayer dielectric film with an interrupted grain structure on conducting layer, said multilayer dielectric film comprising
a first layer comprising a first dielectric material having a first microstructure;
a second layer comprising a second dielectric material on top of said first layer having a second microstructure that is different from the first microstructure; and
a third layer comprising third dielectric material on top of said second layer having a third microstructure that is different from the second microstructure to provide an interrupted grain structure through said multilayer dielectric film, said first, second and third dielectric materials each having a relative dielectric constant of at least 100, said multilayer dielectric film having a thickness in a range from about 0.05 μm to about 10 μm; and
a second conducting layer on a top surface of said multilayer dielectric film.

45. An electroluminescent laminate, comprising;
an electrically insulating substrate;
a conducting metal oxide layer on a surface of the substrate;
an electroluminescent phosphor layer on the conducting metal oxide layer;
a dielectric film on the electroluminescent phosphor layer, said dielectric film having a dielectric constant of at least 100, and said dielectric film has a thickness in a range from about 0.5 μm to about 10 μm; and
a second conducting layer on a top surface of said dielectric film, and wherein at least one of the second conducting layer and the conducting metal oxide layer is substantially transparent, and wherein when only said conducting metal oxide layer is substantially transparent said substrate is also transparent.

46. The electroluminescent laminate according to claims 45 wherein said dielectric material is selected from the group consisting of BaTiO₃, (Sr,Ba)TiO₃, SrTiO₃, PbTiO₃, Pb(Ti,Zr)Ti O₃, Sr(Z,rTi)O₃, (Pb,La)(Zr,Ti)O₃, Pb(Mg,Nb)O₃.

47. The electroluminescent laminate according to claim 45 including a dielectric layer sandwiched between said conducting metal oxide layer and said electroluminescent phosphor layer.

48. The electroluminescent laminate according to claim 47 wherein said dielectric layer (26) sandwiched between said conducting metal oxide layer and said electroluminescent phosphor layer has relative dielectric constant of at least 100, and has a perovskite crystal structure.

49. The electroluminescent laminate according to claim 45 wherein said electroluminescent phosphor layer is an electroluminescent oxide layer.

50. The electroluminescent laminate according to claim 45 wherein said electroluminescent phosphor layer is an electroluminescent sulphide layer.

51. The electroluminescent laminate according to claim 50 wherein said electroluminescent sulphide is selected from the group consisting of ZnS:Mn, SrS:Ce, SrS:Cu,Ag, BaAl₂S₄:Eu and CaS:Pb.

52. The electroluminescent laminate according to claim 47 wherein said dielectric layer (26) has a thickness in a range from about 0.01 μm to about 0.5 μm.

53. The electroluminescent laminate according to claim 45 wherein a thin interface layer is applied to phosphor layer (28) maintain chemical compatibility with dielectric layer (30).

54. The electroluminescent laminate according to claim 47 wherein a thin interface layer is applied to the dielectric layer (26) to maintain chemical compatibility with phosphor layer (28).

55. The electroluminescent laminate according to claim 47 wherein said dielectric film has a thickness in a range from about 0.5 μm to about 10 μm.

56. The electroluminescent laminate according to claim 47 wherein said dielectric film has a relative dielectric constant in the range of from about 4 to about 10,000.

57. The electroluminescent laminate according to claim 47 wherein said dielectric film is a multilayer dielectric film with an interrupted grain structure on the electrode layer, said multilayer dielectric film comprising:
a first layer comprising a first dielectric material having a first microstructure, and at least a second layer comprising a second dielectric material on top of said first layer having a second microstructure that is different from the first microstructure to give an interrupted grain structure through said multilayer dielectric film, wherein said first and second dielectric materials each have a relative dielectric constant of at least 100.

58. The electroluminescent laminate according to claim 47 wherein said dielectric film is a multilayer dielectric film with an interrupted grain structure on the electrode layer, said multilayer dielectric film comprising:
a first layer comprising a first dielectric material having a first microstructure,
a second layer comprising a second dielectric material on top of said first layer having a second microstructure that is different from the first microstructure to give an interrupted grain structure through said multilayer dielectric film; and
a third layer comprising third dielectric material on top of said second layer having a third microstructure that is different from the second microstructure to provide an interrupted grain structure through said multilayer dielectric film wherein said first second and third dielectric materials each have a relative dielectric constant of at least 100.

59. The multilayer dielectric film according to claim 58 wherein said first, second and third dielectric materials are made of the same dielectric material.

60. The multilayer dielectric film according to claim 58 wherein said first, second and third dielectric materials are different dielectric materials.

61. The multilayer dielectric film according to claim 58 wherein any two of said first, second and third dielectric materials are made of the same dielectric material, and the remaining dielectric layer is a different dielectric material.

62. The multilayer dielectric film according to claim 58 wherein said first, second and third dielectric materials are selected from the group consisting of BaTiO₃, (Sr,Ba)TiO₃, SrTiO₃, PbTiO₃, Pb(Ti,Zr)Ti O₃, Sr(Zr,Ti)O₃, (Pb,La)(Zr,Ti)O₃, Pb(Mg,Nb)O₃.

63. The multilayer dielectric film according to claim 58 wherein said multilayer dielectric film has a thickness in a range from about 0.5 μm to about 10 μm.

64. The electroluminescent laminate according to claim 47 wherein said dielectric film is a dielectric film with a thickness in the range of 0.5 μm to 10 μm, having a relative dielectric constant of at least 100.

65. The multilayer dielectric film according to claim 58 wherein said dielectric material has a perovskite crystal structure.

66. An electroluminescent oxide material having a formula Ga₂₋ₓEuₓO₃ wherein 0.10<x<0.30.

67. The electroluminescent oxide material according to claim 66 wherein x is about 0.17.

68. The electroluminescent oxide material according to claim 66 wherein nanocrystalline phases are present in said oxide material.

69. A method of producing electroluminescence, comprising providing an electroluminescent phosphor having a formula Ga₂₋ₓEuₓO₃ wherein 0.10≦x≦0.30, and applying an effective voltage across said electroluminescent phosphor to develop an electric field across said electroluminescent phosphor.

70. The method according to claim 69 wherein x is about 0.17.

71. An electroluminescent device, comprising;
a dielectric substrate, said dielectric substrate having a conducting back electrode on a back surface thereof;
an electroluminescent phosphor on a front surface of said dielectric substrate, said electroluminescent phosphor having a formula Ga₂₋ₓEuₓO₃ wherein 0.10<x<0.30; and
a substantially transparent electrode deposited onto a top surface of said phosphor, means for applying a voltage between said transparent electrode and the conducting back electrode to develop an electric field across said phosphor.

72. The device according to claim 71 wherein x is about 0.17.

73. An electroluminescent laminate, comprising;
an electrically conducting substrate;
an electroluminescent phosphor layer on the electrically conducting substrate;
a multilayer dielectric film with an interrupted grain structure on the electroluminescent phosphor layer, said multilayer dielectric film comprising
a first layer comprising a first dielectric material having first microstructure;
a second layer comprising a second dielectric material on top of said first layer having a second microstructure that is different from the first microstructure, said first and second dielectric materials each having a relative dielectric constant of at least 100; and
a second conducting layer on a top surface of said multilayer dielectric film, and wherein at least one of the second conducting layer and the conducting substrate is substantially transparent, and wherein when only said conducting metal oxide layer is substantially transparent, then said substrate is also transparent.

74. The laminate device according to claim 73 including a third layer comprising third dielectric material on top of said second layer having a third microstructure that is different from the second microstructure to provide an interrupted grain structure through said multilayer dielectric film.
